(19) United States
(12) Patent Application Publication
(10) Pub. No.: US 2010/0112885 A1
(43) Pub. Date: May 6, 2010

(54) High performance liner for power plant emissions systems

(76) Inventors: Joseph Loyd Vandiver, Elgin, SC (US); Harold Raymond Waynick, III, Sumter, SC (US)

Correspondence Address: MONAHAN & MOSES, LLC, 13-B W. WASHINGTON ST., GREENVILLE, SC, 29601, US

(21) Appl. No.: 12/290,753

(22) Filed: Nov. 3, 2008

(51) Int. Cl. B32B 17/10; B32B 37/02; B32B 5/02; B32B 9/04

(52) U.S. Cl. 442/181; 156/280; 156/71; 428/411.1; 428/339

(57) ABSTRACT

A high performance liner for power or other plant emissions systems comprises a layer of blown fiber (preferably glass) and resin forming a flock coat, which is partially and temporarily adhered to the inner faces of the ductwork, and is then overlaid with a series of woven fiber strips that are coated and impregnated with an acid corrosion resistant resin, such as vinyl ester. This lining may be applied throughout the inner faces of the ductwork, and provides corrosion resistance and increased structural integrity to the ductwork. The lining essentially forms a fitted sleeve within the ductwork, which, in its final form, is not reliant on the structural integrity of the original ductwork or adhesion to the original structure of the ductwork in order to function.

### BACKGROUND OF THE INVENTION

The present invention relates generally to a high performance liner that is installed in structure used to carry corrosive materials and the like, such as power plant combustion emission systems or similar plant processes. More specifically, the present invention includes a system and method for repairing and upgrading the ductwork of such structures, by forming essentially an inner protective sleeve, in order to provide increased strength and structural integrity to such ductwork, as well as additional chemical corrosion resistance and abrasion resistance while functioning independently of the level of structural integrity of the original structure and independently of the level of adhesion of liner resins to the interior surface of the original structure.

Often, the ductwork that carries gaseous emissions from the power generator of a power plant through the environmental scrubbing process and out into the atmosphere becomes corroded and eroded through years of exposure to such gaseous emissions. For example, in Flue Gas Desulfurization (FGD) systems, the ductwork is exposed to high temperatures, high acid concentrations (including H₂SO₄), entrained and suspended particulates, and wet/dry interfaces of the condensing acids from suspension in the gaseous flue gas stream. Typically, the power plant emissions system includes a scrubber/absorber to remove sulfur dioxide, or SO₂ and other oxides of Sulphur and Nitrogen as well as chlorides. These gases are generally exposed to an aqueous neutralization stream in the scrubber, causing a reaction with the sulfur dioxide, which can produce calcium sulfite, calcium sulfate and sulfuric acid and other detrimental exposures. The SO₂, SO₃, and H₂SO₄ can cause significant corrosion of the emission system structure, including the ductwork.

When the emissions systems of power plants, or other similar structures, become corroded, eroded or otherwise degraded from years of exposure to such conditions, it becomes necessary to repair and maintain these systems. Replacing such systems can be prohibitively expensive, so other means for extending the life of the emissions systems and ductwork have been developed. One way that has been utilized commercially to extend the life of these systems is by providing a liner within the ductwork and system. These liners are typically applied to the inside of the ducts, tanks, pipes, and other structures used to carry the gaseous emissions, and the liners often include a mat material such as fiberglass in combination with resins, such as polyester, vinyl ester, epoxies, and/or urethane. These liners are used to protect the emissions structures primarily against heat and chemical corrosion. Such liners can offer limited additional structural integrity to the system, but they still rely on the original structure to maintain its structural integrity in order for the system to continue to operate. Thus, if ductwork, for instance, has become corroded to the point where the structural integrity of the system, or a component of the system, is in danger of failing, the liners do not offer enough additional structural integrity to continue to function, which means that the entire section or component of corroded ductwork must be repaired or replaced.

It would be desirable, therefore, to provide a system and method for providing a liner or protective inner sleeve within existing emissions systems and ductwork that would increase the structural integrity and strength of the existing system, without having to repair the original system or replace the entire system or components thereof.

### OBJECTS OF THE INVENTION

Therefore, it is an object of the present invention to provide a lining system for the interior surfaces of power plant emissions structures that increases resistance to chemical corrosion, abrasion and erosion, and provides increased structural integrity to such structures.

Additionally, it is an object of the present invention to provide a lining system for power plant emissions structures that is less costly to install than other lining systems currently on the market.

Further, it is an object of the present invention to provide a lining system for structures that carry corrosive or hazardous materials that provides an inner sleeve having enough additional structural integrity to the system so that the lining, in its final form, is not dependent upon the structural integrity of nor adhesion to the original structure in order to function.

Still another object of the present invention is to provide a novel liner that includes a layer of chopped fiber known as a “flock coat” partially and temporarily adhered to the inner faces of the ductwork, and further includes an additional layer (or layers) of carbon or other fiber strips or mats that are coated by and impregnated with an acid corrosion resistant resin.

Yet another object of the present invention is to provide a liner system for structures used to carry corrosive materials that essentially forms a self-supporting fitted sleeve within such structures.

Another important object of the present invention is to provide a method for lining the inside of a power plant emissions system or similar structure in its entirety, if necessary.

### SUMMARY OF THE INVENTION

In a preferred embodiment, the high performance liner comprises a layer of chopped fiber flock coat, which is partially and temporarily adhered to the inner faces of the structural ductwork, and is then overlaid with a series of woven fiber strips or mats that are coated and impregnated with an acid corrosion resin, such as vinyl ester. This lining may be applied throughout the inner faces of the ductwork, and provides corrosion resistance, abrasion resistance, and increased structural integrity to the ductwork. The lining essentially forms a fitted sleeve within the ductwork, which, in its final form, is not reliant on the structural integrity of nor the adhesion to the original ductwork structure in order to function.

The process for installing the lining includes the following steps. First, the corroded vessel or system is cleaned and prepared for workmen egress, which may include washing with water, pressure washing, possible chemical decontamination, and/or using a vacuum to remove waste. Next the interior surface is examined for holes or penetrations, and large holes are overlaid with an adhesive backed fiberglass cloth, similar to that used to cover holes in drywall repair jobs. Then, the interior of the vessel or system is sprayed with a chopped fiber flock coat and appropriate vinyl ester resin, and allowed to cure. Next, if necessary, the interior surfaces are fitted with pre-fabricated structural components as required by the engineered specifics of the individual installation. Finally the interior surfaces are coated with alternating layers of vinyl ester resin (or some other appropriate resin or adhesive) and fiber mats, each having curing period therebetween. Other additional steps may be employed, depending upon the circumstances and requirements of the installation. It is to be understood that the steps listed above are the basic steps common to most installations of the high performance liner, and that additional steps or modifications of the existing steps may be employed in order to impart certain characteristics or to meet certain requirements of the installation.

### BRIEF DESCRIPTION OF THE DRAWINGS

These and other features, aspects, and advantages of the present invention will become better understood with regard to the following description, appended claims, and accompanying drawings where:

FIG. 1 is a cross sectional drawing of one embodiment of the high performance liner, showing a first layer of chopped, randomly oriented fiber encased within an adhesive resin flock coat, and a second layer comprising a woven fiber mat, which is also encased within an adhesive resin;

FIG. 2 is a cross sectional drawing of a second embodiment of the high performance liner, showing a third layer comprising a woven fiber mat encased within an adhesive resin;

FIG. 3 is a plan view of a duct forming part of a power plant emission system, together with one embodiment of the high performance liner installed on an inner surface of the duct;

FIG. 4 is a cross sectional view of a support column attached to a ceiling portion of an emissions duct, and further including one embodiment of the high performance liner with enhanced abrasion resistance in a localized area;

FIG. 5 is a perspective view of an emissions duct showing several types of support members, including a column, a strut, and a V-brace, each of which is fitted with an embodiment of a high performance liner; and

FIG. 6 is a perspective view of an emissions duct showing several support members in the form of turning vanes, which are fitted with an embodiment of a high performance liner.

### DETAILED DESCRIPTION OF THE INVENTION

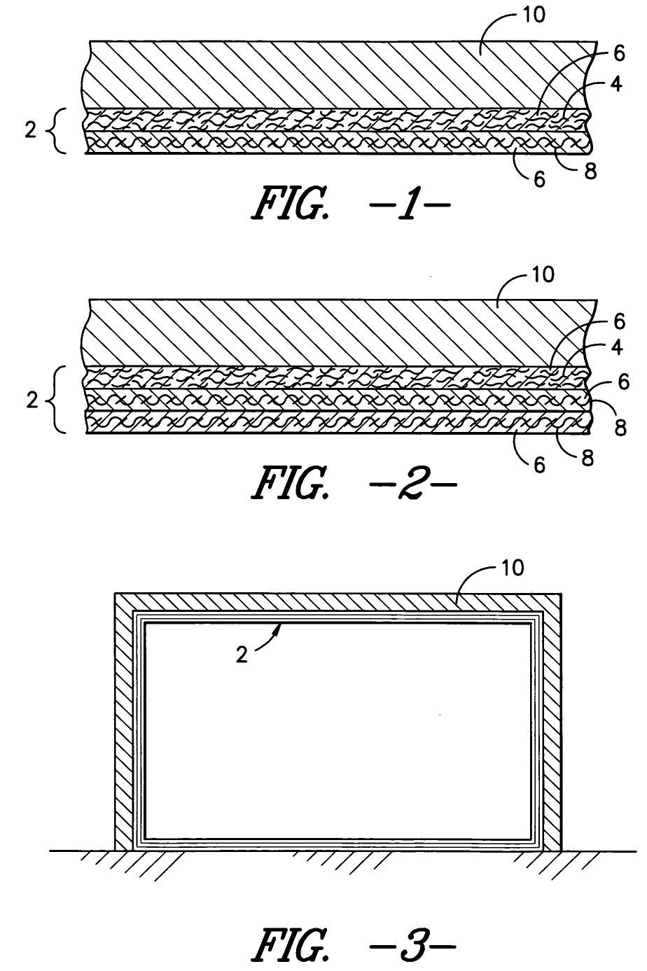

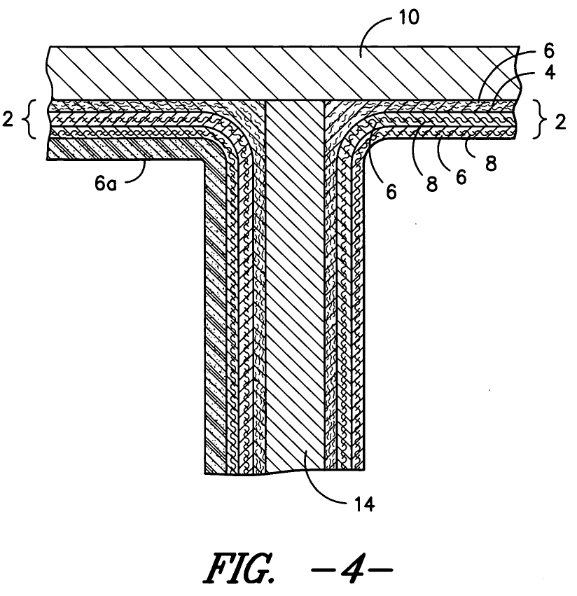

A first embodiment of the high performance liner for power plant emissions systems or other similar structures is illustrated in FIG. 1. In this embodiment, the liner 2 includes a first layer of chopped, randomly oriented fibers 4 (preferably glass fibers) encased within an adhesive resin 6, preferably vinyl ester resin, although other suitable adhesives or resins may be used, such as polyester, epoxies, and/or urethane, to form a flock coat. As used herein, the terms “resin” and “adhesive” may be used interchangeably, and include any substance or compound that be suitable for adhering the various layers together and that may retain those properties during exposure to the environment within typical plant emissions systems or other toxic environments. The second layer of this embodiment comprises a woven fiber mat 8, also encased within an adhesive resin 6. The fiber mat 8 may include glass fibers, carbon fibers, Kevlar® (which is a light, strong para-aramid synthetic fiber commercially available from DuPont), or some combination thereof. Other embodiments of the high performance liner may include additional layers of material (one embodiment of which is shown in FIG. 2), which would typically comprise alternating layers of adhesive or resin and fiber mats. It should also be understood that although woven fiber mats are preferred, other types of mat constructions may be used, including nonwoven mats.

The specific material used in the fiber mats 8, as well as their position within the liner, the construction of the mats, and the dimension and density of the fiber strands within the mat, are determined based on the circumstances and requirements of the installation. For instance, the mat material may be selected by taking into account the spans to be bridged within the ductwork along with the anticipated live loads and allowances for same. Cost is also a factor. Labor costs might be reduced by applying fewer layers to the liner, but in such a case the layers may be more expensive in order to achieve the appropriate level of tensile strength for the system. The number of layers also dictates the time necessary to complete the entire process, because installing more layers requires more time for the installers to work, thus causing more down-time for the entire emission system.

In preparation for installation, the emission system of the power generation plant is cleaned and prepared for workman egress. The cleaning phase may include washing the inner surfaces of the emission system, including ductwork, vessels and other chambers that pass the gaseous emissions through the system. Washing the corroded system may include washing with water, using high pressure water, chemical decontamination, and vacuuming out waste products that are dislodged from the interior. Optionally, abrasive blasting may be used, when necessary, although this method is generally avoided as a precaution against further weakening of an already corroded structure.

During installation of the liner 2, a layer of adhesive backed fiberglass cloth may be applied to the inner walls 10 to bridge significant holes in the original emissions ductwork and structure, if necessary. A mixture of chopped fiberglass 4 and adhesive resin 6 (the flock coat) is then sprayed onto interior surface and partially adhered in place thereby so that the blown chopped fiber/resin flock coat layer preferably has a thickness of about 0.125 inches to 0.375 inches, and this layer is allowed to cure. A coating of resin 6 is then applied to the flock coat layer, and fiber mats 8 are applied to the newly applied layer of resin 6. Optionally, some resin 6 may be applied to the fiber mat 8 prior to application of the mat 8 to the flock coat layer. The fiber mats 8 are then pressed into the layer of resin 6, thereby encasing the fiber mats 8 within the resin 6. This step of pressing the fiber mat into the resin may be performed by using paint rollers, or the like, and additional resin 6 may be applied to the rollers, if necessary. At certain points within the emissions system, the liner 2 reaches a point of termination, where the liner 2 must be tied in with the existing structure at an end point thereof. The term “termination” as used herein refers to tying in such end points of the liner to the original structure, and the manner of accomplishing termination is well known in the art.

Further, it may be desirable to apply additional alternating layers of resin 6 and fiber mats 8 to the liner, depending on the circumstances and requirements of the installation (as shown in FIG. 2). After each fiber mat 8 layer is added and encased in the resin 6, that layer is allowed to cure before additional layers are installed. After the final fiber mat 8 layer is applied, a final coating of resin 6 may be applied thereto.

The curing process allows the chemical reactions to take place in the applied material. It is not always necessary to increase the temperature or apply heat during the curing process, but heat may be applied in order to speed up the curing process. In some cases, it may be necessary to control the temperature and humidity for the entire interior environment. Additionally, it may be necessary to separately control the temperature of the vessel or duct surface. Dehumidification and heating/cooling equipment is commercially available for such purposes.

Sometimes, power plant emissions systems also include structural elements within the ducts or vessels themselves, such as turning vanes 12, as shown in FIG. 6. In such cases, the high performance liner is applied to those surfaces as well, in the manner described above.

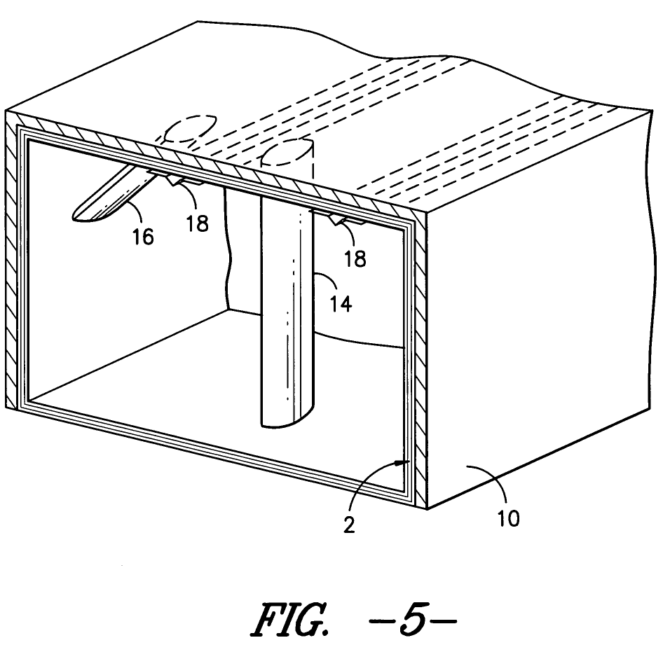

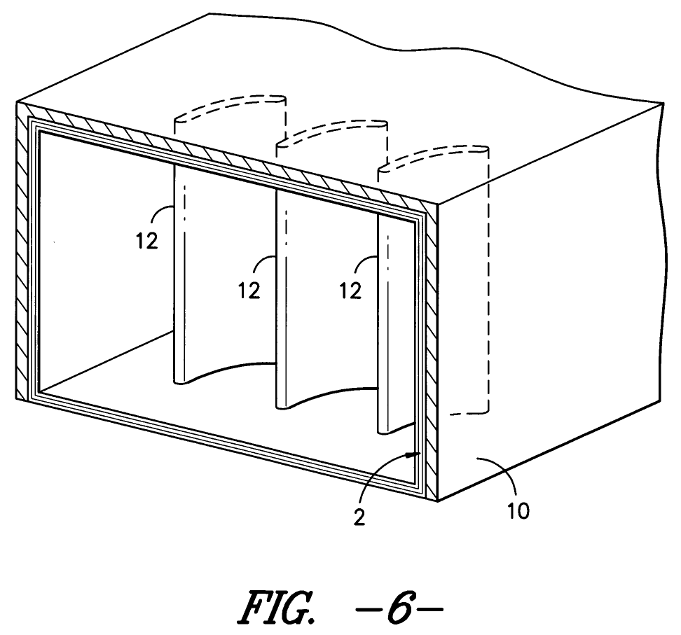

In some cases, the high performance liner 2 may also be augmented with prefabricated structural supports manufactured in the same manner and with the same variables (in terms of fiber materials and geometry) as the interior lining, as shown in FIGS. 4 and 5. These prefabricated supports, which are engineered for the specific application similarly to the liner itself, are installed after the flock coat is applied and are then incorporated into the finished lining with the overlapping layers of adhesive and fiber to form a monolithic system. It may be necessary to temporarily secure these prefabricated supports, using any number of known means, until they are subsequently encapsulated in the alternating layers of fiber and resin that make up the sleeve system. Such prefabricated supports may include columns 14 (shown in FIGS. 4 and 5), struts 16 (shown in FIG. 5), V-braces 18 (shown in FIG. 5), or other types of supports, as desired. The prefabricated support structures may be used to increase the structural integrity of the liner, so that the liner is not dependent upon the structural integrity of the original structure in order to function. Indeed, it is contemplated that the liner, or portions thereof, may eventually become detached from the original structure after installation.

Additionally, the entire lining system may be upgraded for certain purposes. For some installations, the resin 6 may be formulated for increased elasticity, increased temperature capability, chemical resistance enhancements, and/or other physical characteristics. In some cases, it may be necessary to include additional additives within the resin 6a for abrasion resistance, such as alumina or other abrasion resistance additives, in certain areas of the liner. These modifications may also be added after the basic system is installed to enhance the performance of the entire system in specific areas that may be subjected locally to more adverse conditions, as shown in FIG. 4.

The high performance liner 2, in its final form, is essentially a self supporting, fitted sleeve that provides enhanced resistance to high temperatures, chemical corrosion, and abrasion within a power plant emissions system or similar structure. The method of installation provides an efficient and cost effective means for repairing and upgrading existing emissions structures that have become corroded, eroded and generally worn. It is to be understood that although the liner 2 has been described as being useful in power plant emission systems, it may be used in other applications where a structure is used to carry, move or store hazardous waste, chemicals, or any other corrosive substance from one point to another.

Although the present invention has been described in considerable detail with reference to certain preferred versions thereof, other versions are possible. Therefore, the spirit and scope of the appended claims should not be limited to the description of the preferred versions contained herein. All features disclosed in this specification may be replaced by alternative features serving the same, equivalent or similar purpose, unless expressly stated otherwise. Thus, unless expressly stated otherwise, each feature disclosed is one example only of a generic series of equivalent or similar features.

What is claimed is:

1. A high performance liner for structures used to carry corrosive materials and the like, said liner comprising:
a first layer comprising randomly oriented chopped fibers encased in resin partially adhered to an inner surface of said structure;
a second layer comprising a fiber mat encased in said resin, and applied to said first layer.

2. The high performance liner for structures used to carry corrosive materials and the like, set forth in claim 1, wherein said resin is a vinyl ester resin.

3. The high performance liner for structures used to carry corrosive materials and the like set forth in claim 1, wherein said fiber mat includes fibers selected from the group consisting of glass fibers, carbon fibers, para-aramid synthetic fibers, or some combination thereof.

4. The high performance liner for structures used to carry corrosive materials and the like set forth in claim 1, further comprising:
a third layer comprising a fiber mat encased in said resin, said third layer applied to said second layer.

5. The high performance liner for structures used to carry corrosive materials and the like set forth in claim 1, wherein said first layer has a thickness of between about 0.125 inches and about 0.375 inches.

6. The high performance liner for structures used to carry corrosive materials and the like set forth in claim 1, wherein said resin includes aluminum oxide or alumina.

7. The high performance liner for structures used to carry corrosive materials and the like set forth in claim 1, further including adhesive-backed fiberglass mesh cloth applied over holes in said inner surface of said structure, in order to provide a surface to apply said first layer of said chopped fiber encased in said resin.

8. The high performance liner for structures used to carry corrosive materials and the like set forth in claim 1, wherein said fiber mat is woven.

9. A process for installing a high performance liner to the inner surfaces of a structure used to carry corrosive materials and the like, said process comprising the steps of:
cleaning said inner surfaces of said structure;
spraying a first layer comprising randomly oriented chopped fibers mixed with resin onto said inner surface of said structure;
allowing said first layer to cure;
coating said first layer with resin;
applying a second layer comprising a fiber mat to said resin;
encasing said second layer within said resin; and
allowing said second layer to cure.

10. The process for installing a high performance liner to the inner surfaces of a structure used to carry corrosive materials and the like set forth in claim 9, wherein said step of cleaning said inner surfaces of said structure comprises steps selected from the group consisting of washing said inner surfaces with low pressure water, washing said inner surfaces with high pressure water, chemically decontaminating said inner surfaces, vacuuming waste from within said emission system, or a combination thereof.

11. The process for installing a high performance liner to the inner surfaces of a structure used to carry corrosive materials and the like set forth in claim 9, wherein said resin comprises a vinyl ester resin.

12. The process for installing a high performance liner to the inner surfaces of a structure used to carry corrosive materials and the like set forth in claim 9, wherein said fiber mat comprises fibers selected from the group consisting of glass fibers, carbon fibers, para-aramid synthetic fibers, or some combination thereof.

13. The process for installing a high performance liner to the inner surfaces of a structure used to carry corrosive materials and the like set forth in claim 9, wherein said resin includes aluminum oxide or alumina.

14. The process for installing a high performance liner to the inner surfaces of a structure used to carry corrosive materials and the like set forth in claim 9, wherein the curing steps comprise steps selected from the group of controlling environmental temperature, controlling humidity levels, controlling surface temperature of said emissions system structure, or some combination thereof.

15. The process for installing a high performance liner to the inner surfaces of a structure used to carry corrosive materials and the like set forth in claim 9, further including the steps of identifying sections of said inner surface of said structure that define holes or penetrations, and applying an adhesive-backed cloth over said holes or penetrations prior to spraying said inner surfaces of said structure with a first layer of randomly oriented chopped glass fibers and resin.

16. The process for installing a high performance liner to the inner surfaces of a structure used to carry corrosive materials and the like set forth in claim 9, wherein said fiber mat is woven.

17. The process for installing a high performance liner to the inner surfaces of a structure used to carry corrosive materials and the like set forth in claim 9, further including the step of installing a prefabricated support member within said structure.

18. The process for installing a high performance liner to the inner surfaces of a structure used to carry corrosive materials and the like set forth in claim 17, wherein said prefabricated support member is selected from the group consisting of a column, a strut, or a V-brace.

19. The process for installing a high performance liner to the inner surfaces of a structure used to carry corrosive materials and the like set forth in claim 17, further including the steps of:
coating said prefabricated support member with resin; and
applying a fiber mat to said resin coated prefabricated support member so that said fiber mat is encased within said resin.
